(19) United States
(12) Patent Application Publication
(10) Pub. No.: US 2002/0066096 A1
(43) Pub. Date: May 30, 2002

(54) Information distributing system and information distributing method

(75) Inventor: Toshiyuki Ishino, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/989,069

(22) Filed: Nov. 21, 2001

(30) Foreign Application Priority Data
Nov. 24, 2000 (JP) 2000-357240

(51) Int. Cl. G06F 17/60; H04N 7/025; H04N 7/10

(52) U.S. Cl. 725/34; 705/14; 725/35

(57) ABSTRACT

An information distributing system, comprising: an information distributor side device; and audience side terminal unit; wherein the information distributor side device comprises: a database for storing sets of provided information and seller side information, the seller side information representing attributes of an audience to which an information provider wants to distribute the provided information; and a transmitter for distributing the sets to the audience side terminal units, and wherein each of the audience side terminal units comprises: receiver for receiving the sets from the information distributor side device; comparator for comparing each item of the seller side information of each set with each item of buyer side information that represents attributes of an audience who has the audience side terminal unit; and selector for selecting the provided information paired with the seller side information of which the number of matched items with the buyer side information is the maximum.

### BACKGROUND OF THE INVENTION

1. Field of the Invention

The present invention relates to an information distributing system and an information distributing method, and in particular, to those that allow provided information suitable for each audience to be selected from a variety of provided information that is equally distributed to a large number of non-specific audiences.

2. Description of the Prior Art

As an information distributing method for a large number of nonspecific audiences, television broadcasts, radio broadcasts, and so forth have been used for a long time. In such broadcasts, the same information is distributed to a large number of non-specific people. Thus, after an audience has selected a channel, he or she cannot select information from the channel. For example, in a particular TV program of a particular TV broadcast station, at particular time, only one advertisement is broadcast. Thus, the audience cannot select another advertisement. In addition, even if multiplexed advertisements are broadcast, since the audience cannot select his or her desired advertisement, he or she inevitably watches an undesired advertisement. Thus, since the audience cannot watch the advertisement that he or she really wants to watch at his or her convenient time, the effect of the advertisement weakens.

A technology that allows an audience to selectively watches or listens to his or her desired advertisement is described in JPA 11-17633 titled “Advertisement Information Broadcasting Method”. According to the technology, when a received digital broadcast wave contains advertisement information, a target ID added thereto is collated with an attribute of an audience who is pre-registered to an IC card. As a result, advertisement information for which they match is selected and an icon that represents the selected advertisement information is displayed on a screen. When the audience performs an operation for detailed information on the screen, he or she can obtain detailed information with link information contained in the advertisement information.

In addition, a technology for filtering recipients to which information is distributed is disclosed in JPA 9-91358 titled “Information Providing Apparatus and Information Providing Method”. In this technology, an information recipient side registers an advertisement receiving condition with a distributing host computer, whereas an information transmitter side registers an advertisement transmitting condition therewith. Corresponding to the advertisement receiving condition and the advertisement transmitting condition, the distributing host computer creates a distribution list that satisfies both the recipient side and the transmitter side and transmits an advertisement corresponding to the distribution list.

However, according to the technology disclosed in JPA 11-17633, an audience can decide whether or not to watch or listen to an advertisement. Therefore, the audience may not watch or listen to the advertisement, and in this case, the advertisement effect will weaken from a view point of the advertiser.

In addition, according to the technology disclosed in JPA 9-91358, audience information stored in a receiving terminal unit is also registered with the distributing host computer. Since the audience information registered with the distributing host computer is used to identify a recipient side, the receiving terminal unit that each audience can use is fixed to one. In other words, one receiving terminal unit can be used by only one audience. Thus, in order to allow one receiving terminal unit to deal with a plurality of audiences, it is necessary to store audience information of a plurality of audiences to one receiving terminal unit. In addition, when the user of a receiving terminal unit is changed to another user, the new user should register his or her audience information therewith.

### SUMMARY OF THE INVENTION

In order to overcome the aforementioned disadvantage, the present invention has been made and accordingly, has an object to provide an information distributing system that allows information suitable for an audience to be securely distributed thereto.

Another object of the present invention is to provide an information distributing system that allows any audience to use any terminal unit and one terminal unit to be used by a plurality of users.

According to the present invention, there is provided an information distributing system, comprising: an information distributor side device; and a plurality of audience side terminal unit; wherein the information distributor side device comprises: a database for storing a plurality of sets of provided information and seller side information, the seller side information representing attributes of an audience to which an information provider wants to distribute the provided information; and a transmitting means for distributing the plurality of sets to the plurality of audience side terminal units, and wherein each of the plurality of audience side terminal units comprises: receiving means for receiving the plurality of sets from the information distributor side device; comparing means for comparing each item of the seller side information of each set and each item of buyer side information that represents attributes of an audience who has the audience side terminal unit; and selecting means for selecting the provided information paired with the seller side information of which the number of matched items with the buyer side information is the maximum.

In the information distributing system, the provided information may be an advertisement.

In the information distributing system, the seller side information may contain as items at least one of area, zip code, telephone area code, sex, age range, occupation, and hobby of an audience to which the information provider wants to provide the provided information.

In the information distributing system, the buyer side information may contain as items at least one of area, zip code, telephone area code, sex, age range, occupation, and hobby of an audience who receives the provided information.

In the information distributing system, the buyer side information may be stored in an IC card attached to the audience side terminal unit.

The information distributing system will be described in more detail. The information distributing system according to the present invention comprises an information distributor side device (30, FIG. 2) and audience terminal units (11, 12, and 13, FIG. 2).

The information distributor side device has a database (22, FIG. 2) for storing information (letters α, β, and γ, FIG. 2) that the information distributor side device distributes (this information is referred to as provided information) and seller side information (α[n], β[n], and γ[n], FIG. 3) composed of attributes of providers. An information group (Z, FIG. 2) composed of a plurality of sets of provided information and seller side information corresponding thereto is multiplexed and distributed to a plurality of audience terminal units.

Each audience terminal unit comprises an IC card (111, FIG. 4) for storing buyer side information (A[n], B[n], and C[n], FIG. 2) composed of attributes of audiences and an information selecting portion (11a, 12a, and 13a, FIG. 2, equivalent to a digital broadcasting receiving portion 112) for receiving the information group distributed from the information distributor side device, comparing each detail item of seller side information with each detail item of buyer side information, and selecting provided information paired with the seller side information for which the number of matched items with the buyer side information is the maximum.

According to the present invention, an information provider who has contracted with an information distributor stores provided information and seller side information to a database of an information distributor side device. The information distributor side device multiplexes a plurality of sets of provided information and seller side information as an information group and distributes the information group to a plurality of audience side terminal units. Each audience side terminal unit stores buyer side information and compares each item of seller side information with each item of buyer side information. As a result, each audience side terminal unit selects provided information paired with the seller side information for which the number of matched items with the buyer side information is the maximum. In reality, items of the buyer side information are stored in the IC card. Thus, when the IC card is replaced, one audience side terminal unit can be used by a plurality of users. In addition, when one audience attaches his or her IC card to another audience side terminal unit, he or she can use the audience side terminal unit.

In such a manner, according to the present invention, since each audience side terminal unit selects provided information paired with the seller side information for which the number of matched items with the buyer side information is the maximum, the information distributor can distribute provided information (advertisements and so forth) to a large number of non-specific audiences so that the audiences can receive information most suitable therefor while not causing audiences who do not select the distributed provided information at all.

In addition, according to the present invention, buyer side information is stored in an IC card. Thus, the buyer side information can be read by any audience side terminal unit. As a result, one audience can use a plurality of terminal units. In addition, one terminal unit can be used by a plurality of audiences.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a block diagram showing the structure of an information distributing system according to an embodiment of the present invention;

FIG. 2 is a block diagram showing the structure of principal portions of the information distributing system according to the embodiment of the present invention;

FIG. 3 is a schematic diagram showing provided information and seller side information stored in a database as shown in FIG. 2;

FIG. 4 is a block diagram showing the structure of an audience side terminal unit as shown in FIG. 2;

FIG. 5 is a schematic diagram showing the structure of seller side information according to the embodiment of the present invention;

FIG. 6 is a schematic diagram showing the structure of buyer side information according to the embodiment of the present invention; and

FIG. 7 is a timing chart showing the state in which an information group Z according to the embodiment of the present invention is placed in an information providing time zone of one broadcast program.

### DESCRIPTION OF PREFERRED EMBODIMENT

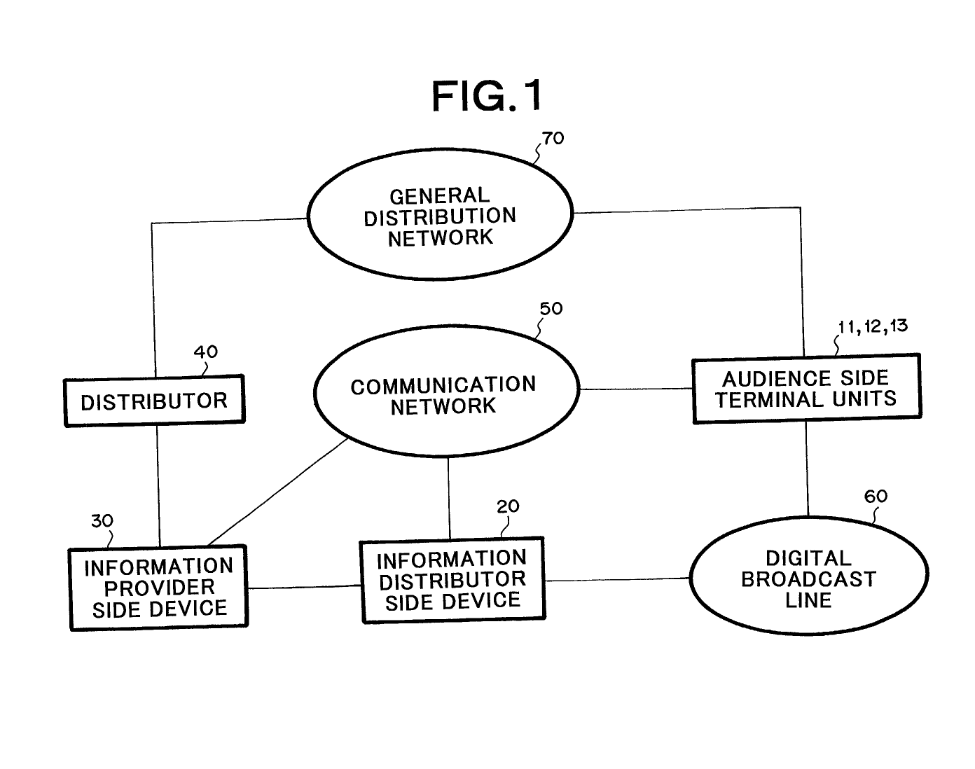

FIG. 1 shows the structure of an information distributing system according to the present invention. Referring to FIG. 1, in the system, an information provider side device 30, an information distributor side device 20 (such as a broadcaster 21), and audience side terminal units 11, 12, and 13 are connected to one another through a communication network 50 such as the Internet so that information can be exchanged thereamong. The information distributor side device 20 distributes provided information provided by the information provider side device 30 to the audience side terminal units 11, 12, and 13 through a digital broadcast line 60. The information provider who has the information provider side device 30 and the audiences who use the audience side terminal units 11, 12, and 13 are connected through a distributor 40 and a general distribution network 70 so that the information provider can deliver commodities to the audiences.

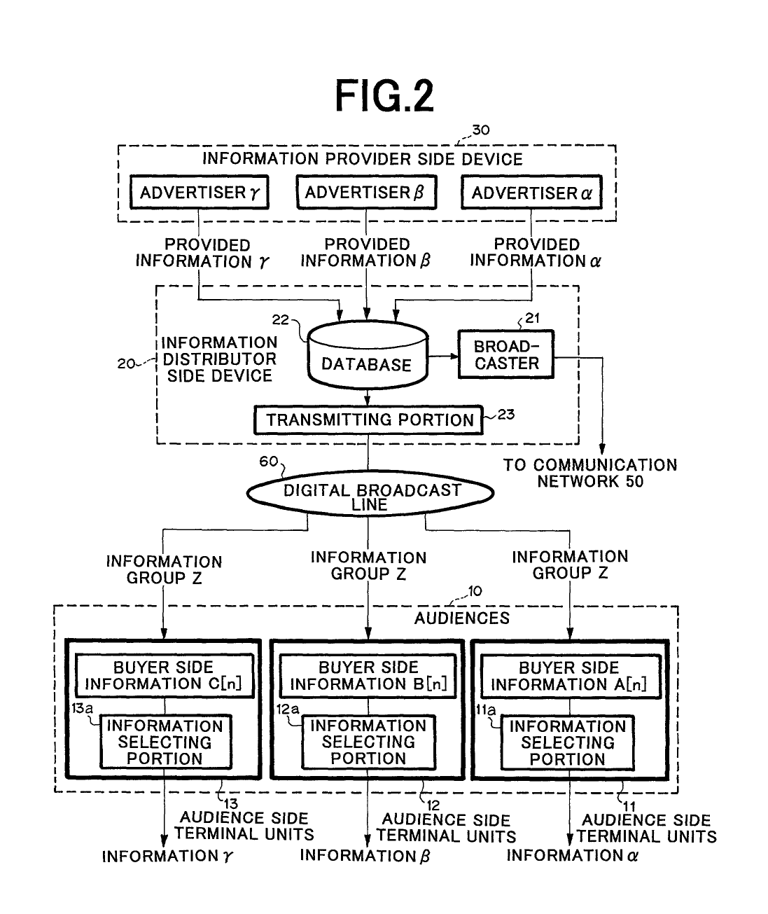

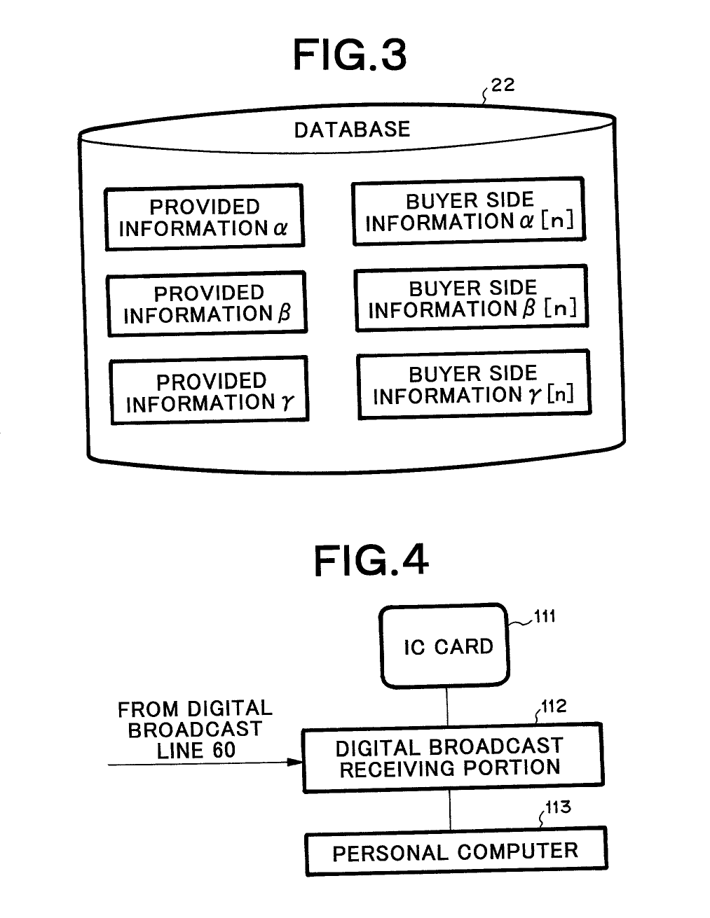

FIG. 2 shows information that flows among the information provider side device 30, the information distributor side device 20, and the audience side terminal units 11, 12, and 13. In FIG. 2, advertisers α, β, and γ are shown as owners of the information provider side device 30 who have contracted the information distributor who has the information distributor side device 20 for information distributions. In addition, the broadcaster 21 is shown as an owner of the information distributor side device 20 that has a database 22. As shown in FIG. 3, the database 22 stores provided information α, β, and γ that the advertisers α, β, and γ want to distribute and corresponding seller side information α[n], β[n], and γ[n]. Seller side information is attributes of an audience to which the information provider side device 30 wants to distribute provided information. Seller side information contains items of for example area, zip code, telephone area code, sex, age range, occupation, and hobby of an audience.

A transmitting portion 23 distributes the provided information α, β, and γ and the seller side information α[n], β[n], and γ[n] (all these information is referred to as “information group Z”) stored in the database 22 to the audience side terminal units 11, 12, and 13 using a digital broadcast transmitting facility through the digital broadcast line 60.

The audience side terminal unit 11 has buyer side information A[n] of audience A and an information selecting portion 11a. The information selecting portion 11a compares each item of the seller side information α[n], β[n], and γ[n] contained in the information group Z that has been multiplexed and distributed through the digital broadcast line 60 with each item of the buyer side information A[n] and selects provided information paired with the seller side information for which the number of matched items with the buyer side information is the maximum (in FIG. 2, the provided information α). Likewise, the audience side terminal unit 12 has buyer side information B[n] of audience B and an information selecting portion 12a. The information selecting portion 12a compares each item of the seller side information α[n], β[n], and γ[n] contained in the information group Z that has been multiplexed and distributed through the digital broadcast line 60 with each item of the buyer side information B[n] and selects provided information paired with the seller side information for which the number of matched items with the buyer side information is the maximum (in FIG. 2, the provided information β). Likewise, the audience side terminal unit 13 has buyer side information C[n] of audience C and an information selecting portion 13a. The information selecting portion 13a compares each item of the seller side information α[n], β[n], and γ[n] contained in the information group Z that has been multiplexed and distributed through the digital broadcast line 60 with each item of the buyer side information C[n] and selects provided information paired with the seller side information of which the number of matched items with the buyer side information is the maximum (in FIG. 2, the provided information γ). Thus, the audience side terminal units 11, 12, and 13 can receive useful information that most matches the attributes of the audiences among the information α, β, and γ that have been multiplexed and distributed.

FIG. 4 shows the detailed structure of the audience side terminal unit 11. The audience side terminal unit 11 comprises a personal computer 113, a digital broadcast receiving portion 112, and an IC card 111. The digital broadcast receiving portion 112 receives a program that is broadcast through the digital broadcast line 60. The IC card 111 has an information storing portion that stores the buyer side information A[n]. The information selecting portion 11a shown in FIG. 2 is accomplished by the digital broadcast receiving portion 112. The personal computer 113 controls the digital broadcast receiving portion 112. The structure and operation of each of the audience side terminal units 12 and 13 are the same as those of the audience side terminal unit 11.

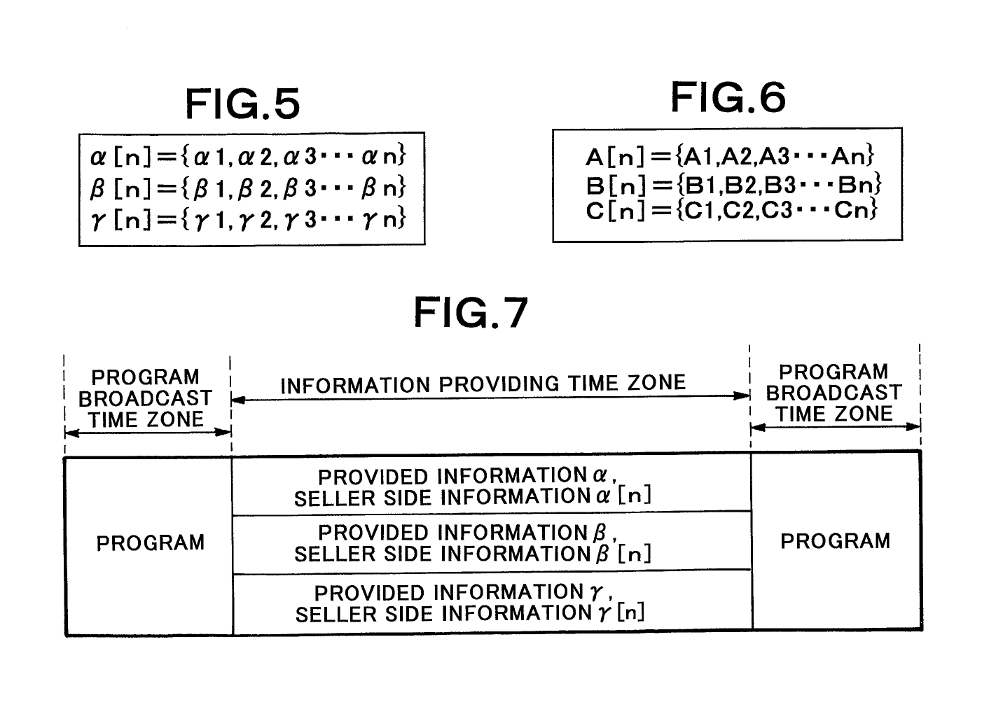

FIG. 5 shows the detailed structure of the seller side information α[n], β[n], and γ[n]. The seller side information α[n] is composed of n items αi (where i=1 to n). As was described above, αi are area, zip code, telephone area code, sex, age range, occupation, and hobby of an audience to which information A is distributed. The structure of each of the seller side information β[n] and γ[n] is the same as that of the seller side information α[n].

FIG. 6 shows the detailed structure of the buyer side information A[n], B[n], and C[n]. The buyer side information A[n] is composed of n items Ai (where i=1 to n). In reality, as was described above, Ai are area, zip code, telephone area code, sex, age range, occupation, and hobby of an audience A. The structure of each of the buyer side information B[n] and C[n] is the same as that of the buyer side information A[n].

Next, the operation of the embodiment will be described.

First, the advertisers α, β, and γ who want to provide provided information such as advertisements contract with the information distributor and then registers the provided information α, β, and γ that they want to distribute with the database 22 of the information distributor side device 20. The information provider may register the provided information α, β, and γ using portable record mediums (CD-Rs, floppy disks, or the like) or through the communication network 50. In addition, the advertisers α, β, and γ create seller side information α[n], β[n], and γ[n] corresponding to the registered provided information α, β, and γ, respectively.

Next, the information group Z composed of the provided information α, the seller side information α[n], the provided information β, the seller side information β[n], the provided information γ, and the seller side information γ[n] registered with the database 22 is distributed by the broadcaster 21 to the audience side terminal units 11, 12, and 13 through the digital broadcast line 60 in an information providing time zone.

FIG. 7 shows the state in which the above-described information group Z is inserted in the information providing time zone of one broadcast program. Referring to FIG. 7, it is clear that the provided information α, the seller side information α[n], the provided information β, the seller side information β[n], the provided information γ, and the seller side information γ[n] are multiplexed in one information providing time zone.

On the other hand, the audience A attaches the IC card 111 that stores the buyer side information A[n] to the audience side terminal unit 11. Likewise, the audiences B and C attach the respective IC cards 111 that store the buyer side information B[n] and C[n] to the audience side terminal units 12 and 13, respectively. In this state, the digital broadcast receiving portion 112 of each of the audience side terminal units 11, 12, and 13 receives the information group Z composed of the information α, the seller side information α[n], the information β, the seller side information β[n], the information γ, and the seller side information γ[n].

First, the operation of the audience side terminal unit 11 will be described. Each item of the buyer side information A[n] of the audience A is compared with each item of each of the seller side information α[n], β[n], and γ[n] contained in the distributed information group Z. It is assumed that when each item of the buyer side information A[n] and each item of the seller side information α[n] are compared (namely, A1 and α1, A2 and α2, A3 and α3, . . . , and An and αn are compared), the number of matched items is i. In addition, it is assumed that when each item of the buyer side information A[n] and each item of the seller side information β[n] are compared (namely, A1 and β1, A2 and β2, A3 and β3, . . . , and An and βn are compared), the number of matched items is k. In addition, it is assumed that when each item of the buyer side information A[n] and each item of the seller side information γ[n] are compared (namely, A1 and γ1, A2 and γ2, A3 and γ3 . . . , and An and yn are compared), the number of matched items is l. Moreover, it is assumed that i is larger than k and l (namely, i>k, l). In this case, the audience side terminal unit 11 selects the provided information α as shown in FIG. 2.

Likewise, the operation of the audience side terminal unit 12 will be described. Each item of the buyer side information B[n] of the audience B and each item of each of the seller side information α[n], β[n], and γ[n] contained in the distributed information group Z are compared. It is assumed that when each item of the buyer side information B[n] and each item of the seller side information α[n] are compared (namely, B1 and α1, B2 and α2, B3 and α3, . . . , and Bn and αn are compared), the number of matched items is p. It is assumed that when each item of the buyer side information B[n] and each item of the seller side information β[n] are compared (namely, B1 and β1, B2 and β2, B3 and β3, . . . , and Bn and βn are compared), the number of matched items is q. In addition, it is assumed that each item of the buyer side information B[n] and each item of the seller side information γ[n] are compared (namely, B1 and γ1, B2 and γ2, B3 and γ3, . . . , and Bn and γn are compared), the number of matched items is r. Moreover, it is assumed that q is larger than p and r (namely, q>p, r). In this case, the audience side terminal unit 12 selects the provided information β as shown in FIG. 2.

Next, the operation of the audience side terminal unit 13 will be described. Each item of the buyer side information C[n] is compared with each item of each of the seller side information α[n], β[n], and γ[n] contained in the distributed information group Z. It is assumed that when each item of the buyer side information C[n] and each item of the seller side information α[n] are compared (namely, C1 and α1, C2 and α2, C3 and α3, . . . , and Cn and αn are compared), the number of matched items is s. It is assumed that when each item of the buyer side information C[n] and each item of the seller side information B[n] are compared (namely, C1 and β1, C2 and β2, C3 and β3, . . . , and Cn and βn are compared), the number of matched items is t. In addition, it is assumed that when each item of the buyer side information C[n] and each item of the seller side information γ[n] are compared (namely, C1 and γ1, C2 and γ2, C3 and γ3, . . . , and Cn and γn are compared), the number of matched items is u. Moreover, it is assumed that u is larger than s and t (namely, u>s, t). In this case, the audience side terminal unit 13 selects the provided information γ as shown in FIG. 2.

If there are a plurality of seller side information as a result of the above comparison, provided information corresponding to the plurality of seller side information is selected. For example, when the relation of j=k>l is satisfied by the audience side terminal unit 11, it selects the provided information α and β.

In such a manner, even if the same information group Z is distributed to all the audience side terminal units, provided information selected from the information group Z differs depending on the contents of the buyer side information of each audience.

In addition, an audience side terminal unit that an audience can use is not fixed. For example, when audience X attaches the IC card 111 that stores buyer side information X[n] therein to the audience side terminal unit 11, the audience X can watch or listen to provided information most suitable therefor using the audience side terminal unit 12.

When the audience A who watched or listened to provided information α of the advertiser a that the audience side terminal unit 11 has selected corresponding to the buyer side information A[n] uses hyperlink information recited in the provided information α and the audience side terminal unit 11 connected to the communication network 50, he or she can obtain additional information beyond the provided information α from the information provider side device of the advertiser a connected to the communication network 50. When the provided information α is commodity information, the audience A can order desired commodity described in the commodity information to the advertiser a through the communication network 50. The advertiser a can deliver the ordered commodity to the audience A through the distributor 40 and the general distribution network 70.

Although the present invention has been shown and described with respect to the best mode embodiment thereof, it should be understood by those skilled in the art that the foregoing and various other changes, omissions, and additions in the form and detail thereof may be made therein without departing from the spirit and scope of the present invention.

What is claimed is:

1. An information distributing system, comprising:
an information distributor side device; and
a plurality of audience side terminal unit;
wherein said information distributor side device comprises:
a database for storing a plurality of sets of provided information and seller side information, said seller side information representing attributes of an audience to which an information provider wants to distribute said provided information; and
a transmitting means for distributing said plurality of sets to said plurality of audience side terminal units, and
wherein each of said plurality of audience side terminal units comprises:
receiving means for receiving said plurality of sets from said information distributor side device;
comparing means for comparing each item of said seller side information of each set with each item of buyer side information that represents attributes of an audience who has the audience side terminal unit; and
selecting means for selecting the provided information paired with the seller side information of which the number of matched items with said buyer side information is the maximum.

2. The information distributing system as set forth in claim 1, wherein the provided information is an advertisement.

3. The information distributing system as set forth in claim 1,
wherein said seller side information contains as items at least one of the area, zip code, telephone area code, sex, age range, occupation, and hobby of an audience to which the information provider wants to provide said provided information.

4. The information distributing system as set forth in claim 1,
wherein said buyer side information contains as items at least one of the area, zip code, telephone area code, sex, age range, occupation, and hobby of an audience who receives said provided information.

5. The information distributing system as set forth in claim 1,
wherein said buyer side information is stored in an IC card attached to said audience side terminal unit.

6. An information distributor side device, comprising:
a database for storing a plurality of sets of provided information and seller side information, said seller side information representing attributes of an audience to which an information provider wants to distribute said provided information; and
a transmitting means for distributing said plurality of sets to a plurality of audience side terminal units.

7. The information distributing device as set forth in claim 6,
wherein the provided information is an advertisement.

8. The information distributing device as set forth in claim 6,
wherein said seller side information contains as items at least one of the area, zip code, telephone area code, sex, age range, occupation, and hobby of an audience to which the information provider wants to provide said provided information.

9. An audience side terminal unit, comprising:
receiving means for receiving a plurality of sets of provided information and seller side information from an information distributor side device, said seller side information representing attributes of an audience to which an information provider wants to distribute said provided information;
comparing means for comparing each item of said seller side information of each set with each item of buyer side information that represents attributes of an audience who has said audience side terminal unit; and
selecting means for selecting provided information paired with the seller side information of which the number of matched items with said buyer side information is the maximum.

10. The audience side terminal unit as set forth in claim 9,
wherein the provided information is an advertisement.

11. The audience side terminal unit as set forth in claim 9,
wherein said seller side information contains as items at least one of the area, zip code, telephone area code, sex, age range, occupation, and hobby of an audience to which the information provider wants to provide said provided information.

12. The audience side terminal unit as set forth in claim 9,
wherein said buyer side information contains as items at least one of the area, zip code, telephone area code, sex, age range, occupation, and hobby of an audience who receives said provided information.

13. the audience side terminal unit as set forth in claim 9,
wherein said buyer side information is stored in an IC card attached to said audience side terminal unit.

14. An information distributing method, comprising the steps of:
storing a plurality of sets of provided information and seller side information to a database of an information distributor side device, said seller side information representing attributes of an audience to which an information provider wants to distribute said provided information;
distributing said plurality of sets from said information distributor side device to a plurality of audience side terminal units;
causing each of said plurality of audience side terminal units to receive said plurality of sets from said information distributor side device;
causing each of said plurality of audience side terminal units to compare each item of said seller side information of each set and each item of buyer side information that represents attributes of an audience who has each of said plurality of said audience side terminal units; and
causing each of said plurality of audience side terminal units to select provided information paired with the seller side information of which the number of matched items with said buyer side information is the maximum.

15. The in formation distributing method as set forth in claim 14,
wherein the provided information is an advertisement.

16. The information distributing method as set forth in claim 14,
wherein said seller side information contains as items at least one of the area, zip code, telephone area code, sex, age range, occupation, and hobby of an audience to which the information provider wants to provide said provided information.

17. The information distributing method as set forth in claim 14,
wherein said buyer side information contains as items at least one of the area, zip code, telephone area code, sex, age range, occupation, and hobby of an audience who receives said provided information.

18. The information distributing method as set forth in claim 14,
wherein the buyer side information is stored in an IC card attached to the audience side terminal unit.
